(19) United States
(12) Patent Application Publication
(10) Pub. No.: US 2025/0102383 A1
(43) Pub. Date: Mar. 27, 2025

(54) MAGNETOSTRICTIVE TORQUE SENSOR

(71) Applicants: NSK Ltd., Tokyo (JP); Proterial, Ltd., Tokyo (JP)

(72) Inventors: Kota FUKUDA, Fujisawa-shi (JP); Seigou URAKAMI, Fujisawa-shi (JP); Akitoshi FUJIMORI, Koto-ku (JP)

(73) Assignees: NSK Ltd., Tokyo (JP); Proterial, Ltd., Tokyo (JP)

(21) Appl. No.: 18/882,911

(22) Filed: Sep. 12, 2024

(30) Foreign Application Priority Data
Sep. 21, 2023 (JP) 2023-155482

(51) Int. Cl. G01L 3/10

(52) U.S. Cl. CPC G01L 3/102

(57) ABSTRACT

A magnetostrictive torque sensor has: a holder having an inner cylindrical portion arranged around a rotating shaft; a side plate portion arranged on one side in an axial direction of the inner cylindrical portion; an outer cylindrical portion arranged on an outer side in a radial direction of the side plate portion; and a recessed accommodating portion communicating an inner space on an inner side in the radial direction of the outer cylindrical portion and an outer space, a cover covering an opening portion on the other side in the axial direction of the recessed accommodating portion, a flexible substrate having a detection portion; and a signal line portion, a part of which is accommodated inside the recessed accommodating portion, and a connector attached to a tip-end portion of the signal line portion, the cover having a connector support portion for supporting the connector.

### TECHNICAL FIELD

The present disclosure relates to a magnetostrictive torque sensor that measures torque applied to a rotating shaft.

### BACKGROUND ART

As a sensor for measuring the torque applied to a rotating shaft, a magnetostrictive torque sensor that measures a torque applied to a rotating shaft by utilizing an inverse magnetostrictive effect that occurs in the rotating shaft when torque is applied to the rotating shaft has been conventionally known, for example, as described in JP 2022-074405 A.

In the torque sensor described in JP 2022-074405 A, a flexible substrate on which a plurality of detection coils is printed is arranged around a rotating shaft, and the torque sensor detects torque applied to the rotating shaft based on changes in inductance of the detection coils.

In the torque sensor described in JP 2022-074405 A, the flexible substrate is housed inside a resin housing. A signal line is connected to each of the detection coils printed on the flexible substrate. The signal lines are bundled into a single cable inside a square tube-shaped guide portion provided on the resin housing to protrude to the outer side in the radial direction and are then pulled out to an external space through the guide portion. The cable is connected to an externally provided detection circuit.

In the torque sensor described in JP 2022-074405 A, a detection coil for detecting a change in inductance is formed by the detection coils printed on the flexible substrate. In other words, according to the torque sensor described in JP 2022-074405 A, it is not necessary to construct each detection coil by winding an insulated wire around a holder, and thus it is possible to reduce manufacturing costs.

### CITATION LIST

### Patent Literature

PATENT LITERATURE 1: JP 2022-074405 A

### SUMMARY OF INVENTION

### Technical Problem

In the torque sensor described in JP 2022-074405 A, the signal wires connected to the detection coils on the flexible substrate are bundled into a single cable inside a square tube-shaped guide portion that is provided on the resin housing to protrude to the outer side in the radial direction and are then pulled out to the external space through the guide portion. Therefore, depending on a shape of a portion to which the torque sensor is attached and a direction of a cable connection destination, work of running the cable may become complicated, increasing the number of assembly steps and raising the assembly costs.

It is possible to change the shape of the guide portion and change the direction in which the cable is pulled out depending on the shape of the portion to which the torque sensor is attached, the direction of the cable connection destination, and the like. However, in this case, it is necessary to prepare a plurality of types of molds in order to manufacture a plurality of resin housings having guide portions with different shapes. This may increase the manufacturing costs of the torque sensor.

An object of the technique according to the present disclosure is to achieve a magnetostrictive torque sensor structure that can easily ensure attachment to a fixed portion.

### Solution to Problem

A magnetostrictive torque sensor according to one aspect of the present disclosure is a sensor for measuring a torque applied to a rotating shaft having magnetostrictive properties, and includes a holder, a cover, a flexible substrate, and a connector.

The holder has an inner cylindrical portion arranged around the rotating shaft; a side plate portion bent on an outer side in a radial direction from an end portion on one side in an axial direction of the inner cylindrical portion; an outer cylindrical portion bent from an end portion on the outer side in the radial direction of the side plate portion toward an other side in the axial direction; and a recessed accommodating portion configured to communicate an inner space located on an inner side in the radial direction of the outer cylindrical portion and an outer space located on the outer side in the radial direction of the outer cylindrical portion, and being open to the other side in the axial direction.

The cover covers an opening portion on the other side in the axial direction of the recessed accommodating portion.

The flexible substrate has a detection portion including a plurality of detection coils and arranged around the inner cylindrical portion; and a signal line portion including a plurality of signal lines electrically connected to the plurality of detection coils, a part of the signal line portion being accommodated inside the recessed accommodating portion.

The connector is attached to a tip-end portion of the signal line portion.

Particularly, in this magnetostrictive torque sensor, the cover has a connector support portion for supporting the connector.

In the magnetostrictive torque sensor according to one aspect of the present disclosure, the cover may have a covering plate portion configured to cover the opening portion on the other side in the axial direction of the recessed accommodating portion, and a support plate portion including the connector support portion.

In the magnetostrictive torque sensor according to one aspect of the present disclosure, the connector support portion may be configured by a slit, and the connector can be supported by the cover by engaging a part of the connector with the slit.

In the magnetostrictive torque sensor according to one aspect of the present disclosure, the cover may have a protruding portion arranged inside the recessed accommodating portion, one of the recessed accommodating portion and the protruding portion may have a protruding corner portion having increased contact surface pressure with the signal line portion in a case in which the signal line portion is pulled toward the outer space; and the other of the recessed accommodating portion and the protruding portion may have a recessed corner portion facing the protruding corner portion.

In the magnetostrictive torque sensor according to one aspect of the present disclosure, a magnetic ring arranged around the detection portion may be provided.

In the magnetostrictive torque sensor according to one aspect of the present disclosure, the holder may have a cylindrical surface-shaped holder side fitting surface, and a holder side locking hole, and the magnetic ring may have a ring side fitting surface configured to fit with the holder side fitting surface and a ring side locking hole. In this magnetostrictive torque sensor, a positioning member extending between the holder side locking hole and the ring side locking hole may be provided.

In the magnetostrictive torque sensor according to one aspect of the present disclosure, the holder side fitting surface and the ring side fitting surface can be fitted together without any looseness in the radial direction. In this case, specifically, the holder side fitting surface and the ring side fitting surface can be fitted together with a spigot-fit that is a clearance fit with no looseness in the radial direction.

In the magnetostrictive torque sensor according to one aspect of the present disclosure, the holder side locking hole may penetrate the holder in the radial direction, and the positioning member can be caused to protrude in the radial direction from an opening portion of the opening portions on both sides in the radial direction of the holder side locking hole that is on an opposite side to the magnetic ring.

In the magnetostrictive torque sensor according to one aspect of the present disclosure, a plurality of combinations of the holder side locking hole, the ring side locking hole, and the positioning member may be provided. Alternatively, one combination of the holder side locking hole, the ring-side locking hole, and the positioning member may be provided.

In the magnetostrictive torque sensor according to one aspect of the present disclosure, the positioning member may be configured by a spring pin. Alternatively, the positioning member may be configured by a columnar or cylindrical pin, a screw, or the like.

In the magnetostrictive torque sensor according to one aspect of the present disclosure, the holder side fitting surface may be provided on an inner circumferential surface of the outer cylindrical portion, and the ring side fitting surface may be provided on an outer circumferential surface of the magnetic ring.

In a case of implementing the magnetostrictive torque sensor according to the present disclosure, the above-described aspects may be implemented in any suitable combination as long as no contradiction occurs.

### Effect of Invention

With the magnetostrictive torque sensor according to one aspect of the present disclosure, it is possible to easily ensure attachability to a fixed portion.

### BRIEF DESCRIPTION OF THE DRAWINGS

FIG. 1 is a perspective view illustrating a magnetostrictive torque sensor of an example of an embodiment according to the present disclosure.

FIG. 2 is a perspective view illustrating the magnetostrictive torque sensor of this example, as viewed from the opposite side in the axial direction to FIG. 1.

FIG. 3 is an exploded perspective view illustrating the magnetostrictive torque sensor of this example.

FIG. 4 is an exploded perspective view illustrating the magnetostrictive torque sensor of this example, as viewed from the opposite side in the axial direction to FIG. 3.

FIG. 5 is a cross-sectional view of the magnetostrictive torque sensor of this example.

FIG. 6 is a partially enlarged cross-sectional view illustrating a detection portion of a flexible substrate.

FIG. 7A to FIG. 7D are developed view of first to fourth wiring layers as viewed from the outer side in the radial direction.

FIG. 8 is a schematic view illustrating a detection circuit including four detection coils.

FIG. 9 is a developed view of the flexible substrate.

FIG. 10A is an end view of the magnetostrictive torque sensor of this example as viewed from a lower left side of FIG. 1 with respect to the axial direction, and with a support plate portion of a cover, a connector, and a magnetic ring being omitted, and FIG. 10B is an end view with the cover in FIG. 10A being omitted.

FIG. 11A is a partially enlarged view of a holder accommodating portion as viewed from the axial direction, and FIG. 11B is a partially enlarged perspective view illustrating a peripheral portion of the holder accommodating portion with a part cut away.

FIG. 12A is a perspective view illustrating a covering plate portion of the cover, and FIG. 12B is a view as seen from the opposite side to FIG. 12A.

FIG. 13 is a cross-sectional view illustrating a state in which the magnetostrictive torque sensor of this example is attached to a fixed portion.

FIG. 14A to FIG. 14C are partially enlarged cross-sectional views illustrating three variations of modified shapes of a recessed accommodating portion and a protruding portion of the cover.

FIG. 15 is a perspective view illustrating another example of a supporting form of the connector.

FIG. 16 is a perspective view as seen from the opposite side in the axial direction to FIG. 15.

### DESCRIPTION OF EMBODIMENTS

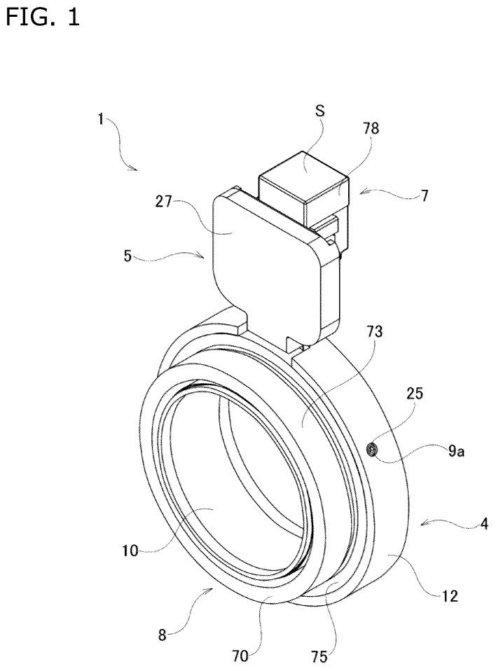

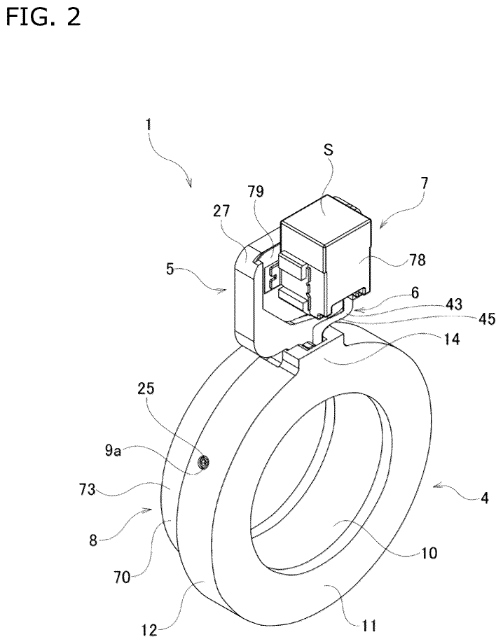

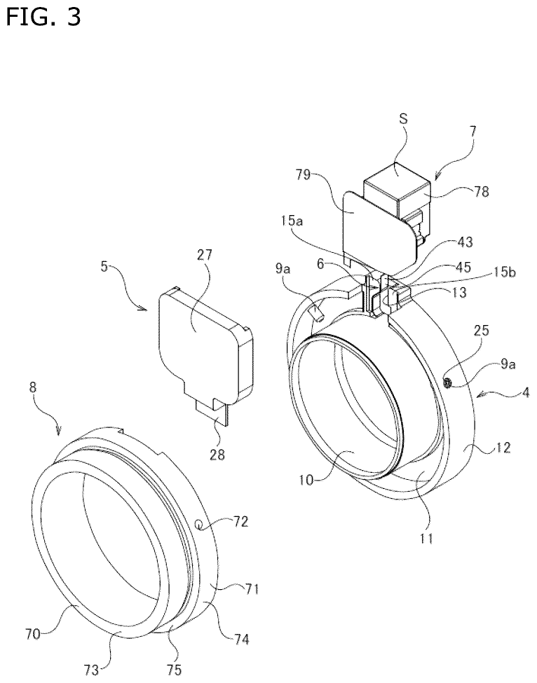

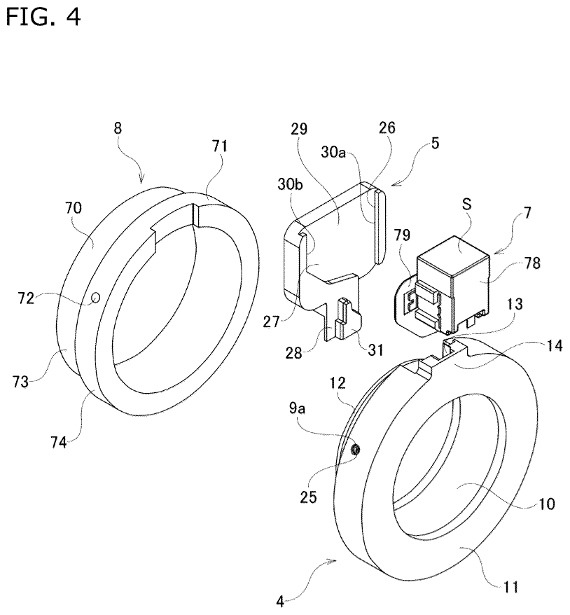

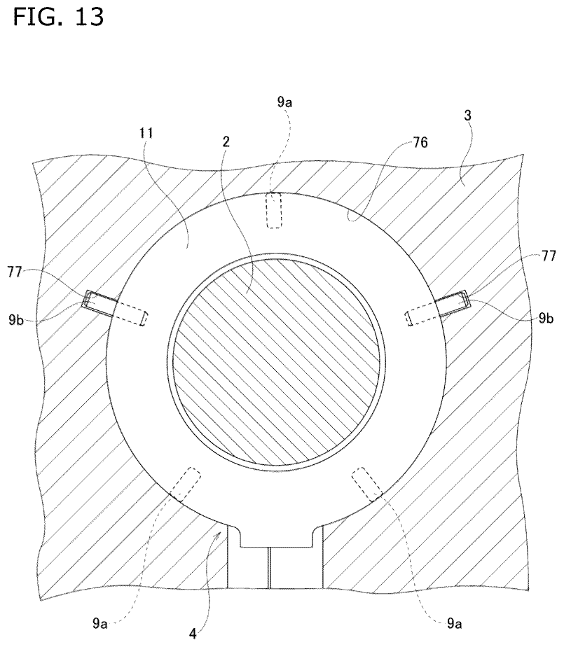

An example of an embodiment according to the present disclosure will be described with reference to FIGS. 1 to 16.

The magnetostrictive torque sensor 1 of this example is a sensor that measures torque applied to a rotating shaft 2, and is used in a state of being supported by and fixed to a fixed portion 3, such as a housing, that does not rotate even when in use. The magnetostrictive torque sensor 1 includes a holder 4, a cover 5, a flexible substrate 6, and a connector 7. Furthermore, the magnetostrictive torque sensor 1 of this example includes a magnetic ring 8 and positioning members 9a, 9b.

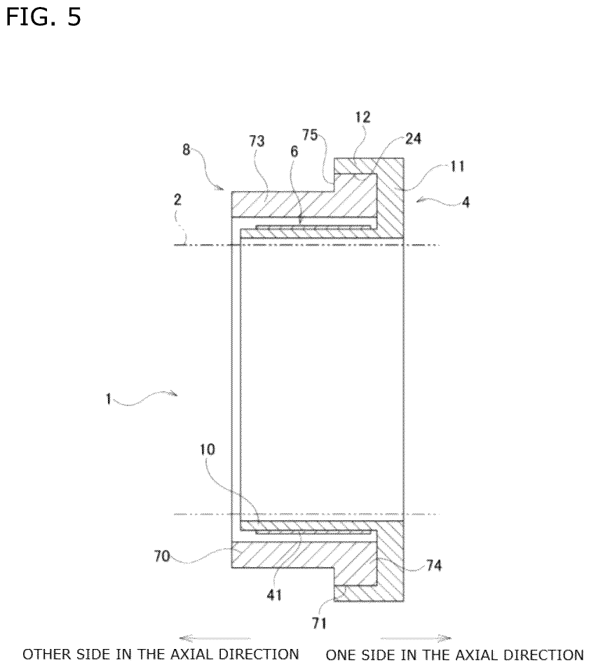

In the following description, the axial direction, radial direction, and circumferential direction of the magnetostrictive torque sensor 1 refer to the axial direction, radial direction, and circumferential direction of the rotating shaft 2 unless otherwise specified. The axial direction, the radial direction and the circumferential direction of the rotating shaft 2 coincide with the axial direction, the radial direction and the circumferential directions of the holder 4 and also coincide with the axial direction, the radial direction and the circumferential direction of the magnetic ring 8. Moreover, one side in the axial direction refers to the right side in FIG. 5, and the other side in the axial direction refers to the left side in FIG. 5.

The holder 4 has an inner cylindrical portion 10, a side plate portion 11, an outer cylindrical portion 12, and a recessed accommodating portion 13.

The inner cylindrical portion 10 is arranged around the rotating shaft 2 coaxially with the rotating shaft 2 in a state in which the magnetostrictive torque sensor 1 is supported by and fixed to the fixed portion 3.

In this example, the inner cylindrical portion 10 has a cylindrical shape. That is, the inner cylindrical portion 10 has an inner circumferential surface whose inside diameter does not change along the axial direction, and an outer circumferential surface whose outside diameter does not change along the axial direction.

The side plate portion 11 is bent to the outer side in the radial direction from an end portion on the one side in the axial direction of the inner cylindrical portion 10. An end portion on the outer side in the radial direction of the side plate portion 11 is connected to an end portion on the one side in the axial direction of the outer cylindrical portion 12. That is, the side plate portion 11 connects the end portion on the one side in the axial direction of the inner cylindrical portion 10 and the end portion on the one side in the axial direction of the outer cylindrical portion 12. In addition, the outer cylindrical portion 12 is arranged coaxially with the inner cylindrical portion 10.

In this example, the side plate portion 11 is bent to the outer side in the radial direction from a portion of the end portion on the one side in the axial direction of the inner cylindrical portion 10 that excludes a portion where the recessed accommodating portion 13 is provided. That is, in this example, the side plate portion 11 has an end surface shape that is substantially C-shaped when viewed in the axial direction.

The outer cylindrical portion 12 is bent from the end portion on the outer side in the radial direction of the side plate portion 11 toward the other side in the axial direction around the entire circumference except where the recessed accommodating portion 13 is provided. That is, the outer cylindrical portion 12 has a partially cut cylindrical shape as a whole.

In this example, a length in the axial direction of the outer cylindrical portion 12 is shorter than a length in the axial direction of the inner cylindrical portion 10. Therefore, a portion on the other side in the axial direction of the inner cylindrical portion 10 protrudes further toward the other side in the axial direction than an end portion on the other side in the axial direction of the outer cylindrical portion 12.

The recessed accommodating portion 13 communicates between an inner space present on the inner side in the radial direction of the outer cylindrical portion 12 and an outer space present on the outer side in the radial direction of the outer cylindrical portion 12, and is open on the other side in the axial direction.

The holder 4 of this example includes a bottom plate portion 14 and two side wall portions 15a, 15b, by which the recessed accommodating portion 13 is formed.

The bottom plate portion 14 is configured in a substantially rectangular flat plate shape. A side surface on the one side in the axial direction of the bottom plate portion 14 is on the same plane as a side surface on the one side in the axial direction of the side plate portion 11, and a side surface on the other side in the axial direction of the bottom plate portion 14 is on the same plane as a side surface on the other side in the axial direction of the side plate portion 11.

The side wall portions 15a, 15b protrude from portions on both sides in the circumferential direction of the side surface on the other side in the axial direction of the bottom plate portion 14 toward the other side in the axial direction.

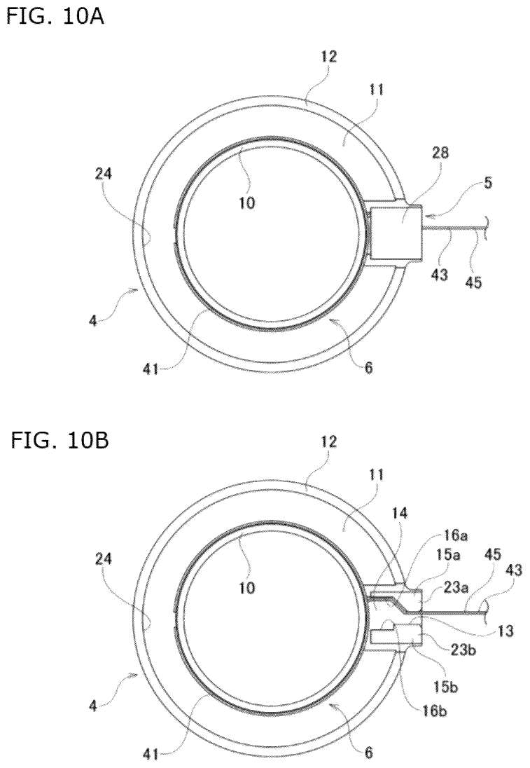

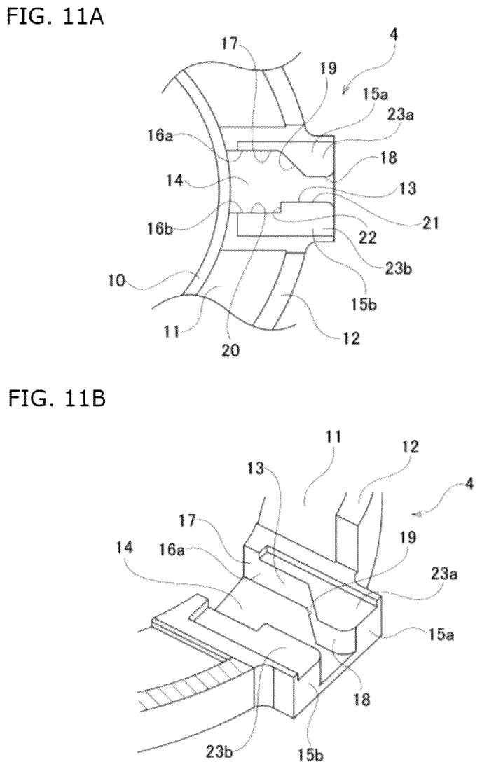

As shown in FIG. 10B to FIG. 11B, the recessed accommodating portion 13 is formed by a portion surrounded on three sides by the side surface on the other side in the axial direction of the bottom plate portion 14 and opposing surfaces 16a, 16b of the side wall portions 15a, 15b that face each other.

Of the two side wall portions 15a, 15b, the opposing surface 16a of one side wall portion 15a is configured by connecting a holder side first guide surface 17 on the inner side in the radial direction and a holder side second guide surface 18 on the outer side in the radial direction by a holder side inclined guide surface 19. The holder side second guide surface 18 is arranged offset farther toward the side near the other side wall portion 15b than the holder side first guide surface 17. Moreover, the holder side first guide surface 17 and the holder side second guide surface 18 are arranged substantially parallel to each other. The holder side inclined guide surface 19 is inclined in a direction approaching the other side wall portion 15b as going to the outer side in the radial direction.

The opposing surface 16b of the other side wall portion 15b is configured by connecting a holder side first flat surface 20 on the inner side in the radial direction and a holder side second flat surface 21 on the outer side in the radial direction by a stepped surface 22 facing to the inner side in the radial direction. The holder side second flat surface 21 is arranged offset farther toward the side closer to the one side wall portion 15a than the holder side first flat surface 20. In addition, the holder side first flat surface 20 and the holder side second flat surface 21 are arranged substantially parallel to each other.

Each of the side wall portions 15a, 15b has, on the side surface on the other side in the axial direction, a flat surface shaped pedestal surface 23a, 23b perpendicular to a central axis of the holder 4. The pedestal surfaces 23a, 23b of the side wall portions 15a, 15b are arranged offset farther toward the one side in the axial direction than remaining portions.

The holder 4 further has a holder side fitting surface 24 having a cylindrical surface shape, and a holder side locking hole 25.

In this example, the holder side fitting surface 24 is provided on an inner circumferential surface of the outer cylindrical portion 12. More specifically, the holder side fitting surface 24 is provided on the entire inner circumferential surface of the outer cylindrical portion 12 and is configured as a single cylindrical surface whose inner diameter does not change in the axial direction.

The holder side locking hole 25 is provided so as to penetrate the outer cylindrical portion 12 in the radial direction at one or more locations in the circumferential direction. In this example, the holder side locking holes 25 are provided at five locations of the outer cylindrical portion 12 at equal intervals in the circumferential direction, which are offset in the circumferential direction from the location where the recessed accommodating portion 13 is provided.

The holder 4 is configured by a synthetic resin, which is a non-magnetic and non-conductive (insulating) material. More specifically, the holder 4 is made of an epoxy resin, or a thermoplastic resin such as polyphenylene sulfide (PPS), polyamide (PA), or polyphthalamide (PPA). In addition, in this example, the holder 4 is integrally formed by injection molding of synthetic resin. However, in a case of implementing the magnetostrictive torque sensor according to the present disclosure, the holder may also be configured by combining a plurality of parts.

The cover 5 covers an opening portion on the other side in the axial direction of the recessed accommodating portion 13. Moreover, the cover 5 has a connector support portion 26 for supporting the connector 7.

The cover 5 has a support plate portion 27 including the connector support portion 26, and a covering plate portion 28 that covers the opening portion on the other side in the axial direction of the recessed accommodating portion 13.

In this example, the support plate portion 27 is configured in a substantially rectangular plate shape. The support plate portion 27 has a recessed portion 29 on a side surface on the one side in the axial direction, and slits (recessed grooves) 30a, 30b on side surfaces of the recessed portion 29 facing each other in the circumferential direction. In this example, the connector 7 is supported with respect to the cover 5 by locking edge portions on both sides in the width direction of a supported plate portion 79 of the connector 7 with the slits 30a, 30b. That is, in this example, the connector support portion 26 is configured by the slits 30a, 30b.

The covering plate portion 28 is configured in a substantially rectangular plate shape. In this example, the covering plate portion 28 is provided so as to extend to the inner side in the radial direction from an intermediate portion in the circumferential direction of an end portion on the inner side in the radial direction of the support plate portion 27.

The cover 5 further has a protruding portion 31 arranged inside the recessed accommodating portion 13.

In this example, the protruding portion 31 is provided so as to protrude from an intermediate portion in the circumferential direction of a side surface on the one side in the axial direction of the covering plate portion 28 toward the one side in the axial direction.

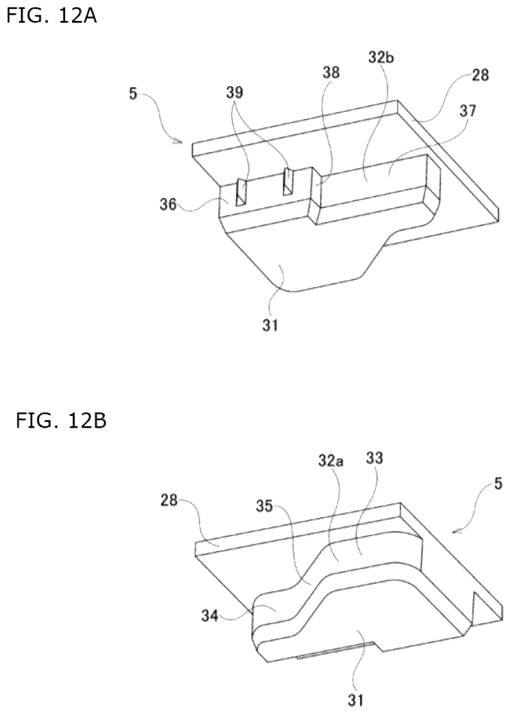

As illustrated in FIG. 12A and FIG. 12B, of a pair of outer side surfaces 32a, 32b facing opposite directions with respect to the circumferential direction of the protruding portion 31, one outer side surface 32a facing the opposing surface 16a of the one side wall portion 15a has a shape that follows the opposing surface 16a. More specifically, the one outer side surface 32a is configured by connecting a cover side first guide surface 33 on the inner side in the radial direction and a cover side second guide surface 34 on the outer side in the radial direction by a cover side inclined guide surface 35. The cover side second guide surface 34 is arranged to be offset nearer to the other outer side surface 32b than the cover side first guide surface 33. In addition, the cover side first guide surface 33 and the cover side second guide surface 34 are arranged substantially parallel to each other. The cover side inclined guide surface 35 is inclined in a direction approaching the other outer side surface 32b as going to the outer side in the radial direction.

The other outer side surface 32b has a shape that follows the opposing surface 16b of the other side wall portion 15b. More specifically, the other outer side surface 32b is configured by connecting a cover side first flat surface 36 on the inner side in the radial direction and a cover side second flat surface 37 on the outer side in the radial direction by a stepped surface 38 facing the outer side in the radial direction. The cover side second flat surface 37 is arranged to be offset nearer to the one outer side surface 32a than the cover side first flat surface 36. Moreover, the cover side first flat surface 36 and the cover side second flat surface 37 are arranged substantially parallel to each other.

In this example, the protruding portion 31 has a protrusion 39 that protrudes from the other outer side surface 32b. In this example, the protrusion 39 is provided respectively at two positions in the radial direction on the cover side first flat surface 36.

The cover 5 is supported by the holder 4 by press-fitting the protruding portion 31 into the recessed accommodating portion 13. In a state that the protruding portion 31 is press-fitted into the recessed accommodating portion 13, the protrusions 39 are pressed against the holder side first flat surface 20 and are elastically deformed. Therefore, the protruding portion 31 is biased in a direction in which the one outer side surface 32a is pressed against the opposing surface 16a of the one side wall portion 15a by a force of the protrusions 39 attempting to elastically return to the original shape. In addition, in a state in which the cover 5 is supported by the holder 4, the opening portion on the other side in the axial direction of the recessed accommodating portion 13 is covered by portions on both sides in the circumferential direction of the side surface on the one side in the axial direction of the covering plate portion 28 coming in contact with the pedestal surfaces 23a, 23b.

The cover 5 is made of a synthetic resin, which is a non-magnetic and non-conductive (insulating) material. More specifically, the cover 5 is made of an epoxy resin, or a thermoplastic resin such as polyphenylene sulfide (PPS), polyamide (PA), or polyphthalamide (PPA). In addition, in this example, the cover 5 is integrally formed by injection molding of synthetic resin.

The flexible substrate 6 has: a detection portion 41 having a plurality of detection coils 40a to 40d for detecting a magnetic field of the rotating shaft 2 and arranged around the inner cylindrical portion 10 of the holder 4; and a signal line portion 43 having a plurality of signal lines 53a to 53d for electrically connecting the detection portion 41 and an external device 42, a part of which is accommodated inside the recessed accommodating portion 13.

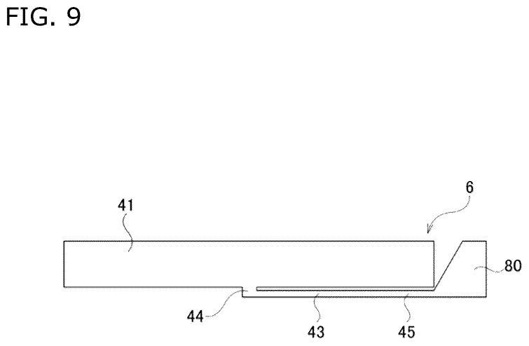

In a developed state of the flexible substrate 6 as illustrated in FIG. 9, the detection portion 41 is configured in a belt-like or rectangular plate-like shape. In addition, when the flexible substrate 6 is in a developed state, the signal line portion 43 has a protruding portion 44 protruding in the short side direction from one long side of the detection portion 41, a linear portion 45 extending in the long side direction from the protruding portion 44, and a trapezoidal plate-shaped sensor side contact mounting portion 80 provided at a tip-end portion of the linear portion 45.

The film of the flexible substrate 6, that is, a cover film and/or a base film, is obtained by subjecting a base material to a punching process using a punching die. More specifically, a plurality of films are punched out from one base material at once.

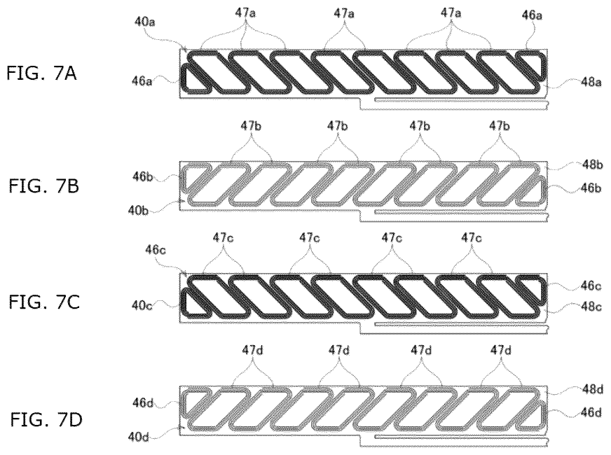

In this example, the detection portion 41 has four detection coils 40a to 40d. Each of the detection coils 40a to 40d is configured by arranging a plurality of coil pieces 46a to 46d, 47a to 47d in the circumferential direction (long side direction of the detection portion 41 when the flexible substrate 6 is in the developed state) as illustrated in FIG. 7A to FIG. 7D.

More specifically, a first detection coil 40a is configured by connecting a plurality of coil pieces 46a, 47a arranged in the circumferential direction in series; a second detection coil 40b is configured by connecting a plurality of coil pieces 46b, 47b arranged in the circumferential direction in series; a third detection coil 40c is configured by connecting a plurality of coil pieces 46c, 47c arranged in the circumferential direction in series; and a fourth detection coil 40d is configured by connecting a plurality of coil pieces 46d and 47d arranged in the circumferential direction in series.

Of the coil pieces 46a to 46d, 47a to 47d, the coil pieces 46a to 46d arranged at end portions on both sides in the circumferential direction are configured by arranging a wiring pattern so as to wind around in an approximately triangular shape when viewed in the radial direction, and the remaining coil pieces 47a to 47d are configured by arranging a wiring pattern so as to wind around in an approximately parallelogram shape when viewed in the radial direction.

The coil pieces 46a, 47a of the first detection coil 40a, and the coil pieces 46c, 47c of the third detection coil 40c have straight line portions inclined at a predetermined angle (for example, +45 degrees) in a predetermined direction relative to the axial direction of the rotating shaft 2 (the short side direction of the detection portion 41 when the flexible substrate 6 is in the developed state). The coil pieces 46b, 47b of the second detection coil 40b and the coil pieces 46d, 47d of the fourth detection coil 40d have straight line portions inclined at a predetermined angle (for example, −45 degrees) in the opposite direction to the predetermined direction with respect to the axial direction of the rotation shaft 2.

The four detection coils 40a to 40d are arranged overlapping each other in the radial direction. More specifically, the first detection coil 40a, the second detection coil 40b, the third detection coil 40c, and the fourth detection coil 40d are arranged in this order from the outer side in the radial direction.

For this reason, in this example, the flexible substrate 6 has a multi-layer structure having a plurality of wiring layers 48a to 48d.

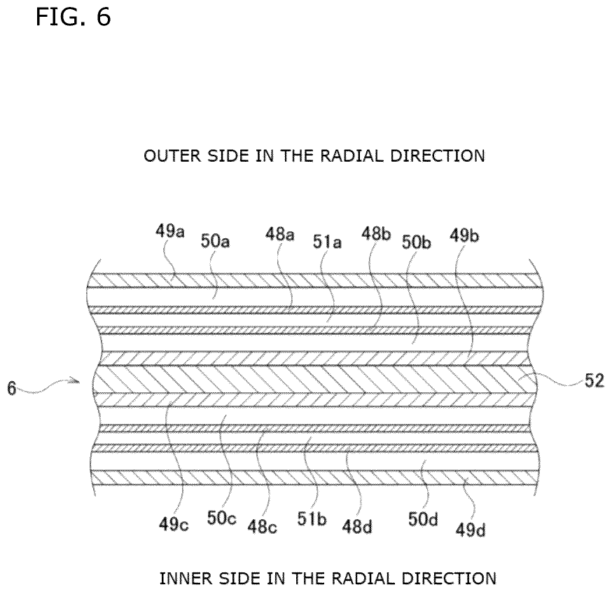

In this example, the flexible substrate 6 has four wiring layers 48a to 48d. More specifically, as shown in FIG. 6, the flexible substrate 6 is configured by stacking in order from the outer side in the radial direction a first coverlay film 49a, a first adhesive layer 50a, a first wiring layer 48a, a first base film 51a, a second wiring layer 48b, a second adhesive layer 50b, a second coverlay film 49b, a double-sided tape 52, a third coverlay film 49c, a third adhesive layer 50c, a third wiring layer 48c, a second base film 51b, a fourth wiring layer 48d, a fourth adhesive layer 50d, and a fourth coverlay film 49d.

Each of the coverlay films 49a to 49d and the base films 51a and 51b is made of an insulating material such as polyimide or polyester in the form of a thin film. The coverlay films 49a to 49d are protective films for protecting the wiring layers 48a to 48d.

Each of the wiring layers 48a to 48d is configured by a wiring pattern formed by etching copper foil. The first wiring layer 48a is formed on an outer surface in the radial direction of the first base film 51a, and the second wiring layer 48b is formed on an inner surface in the radial direction of the first base film 51a. The third wiring layer 48c is formed on an outer surface in the radial direction of the second base film 51b, and the fourth wiring layer 48d is formed on an inner surface in the radial direction of the second base film 51b.

The adhesive layers 50a to 50d are each made of an adhesive that bonds the coverlay films 49a to 49d, the wiring layers 48a to 48d, and the base films 51a and 51b to each another. More specifically, each of the adhesive layers 50a to 50d is made of an epoxy resin-based or acrylic resin-based adhesive.

The double-sided tape 52 bonds the second coverlay film 49b and the third coverlay film 49c together.

In this example, the first detection coil 40a is formed in the first wiring layer 48a, the second detection coil 40b is formed in the second wiring layer 48b, the third detection coil 40c is formed in the third wiring layer 48c, and the fourth detection coil 40d is formed in the fourth wiring layer 48d.

The detection coils 40a to 40d of the detection unit 41 are electrically connected to an external device 42 by signal lines 53a to 53d provided in the signal line portion 43 and a connector 7, a cable connected to the external device 42 and a device-side connector provided at the tip-end portion of the cable.

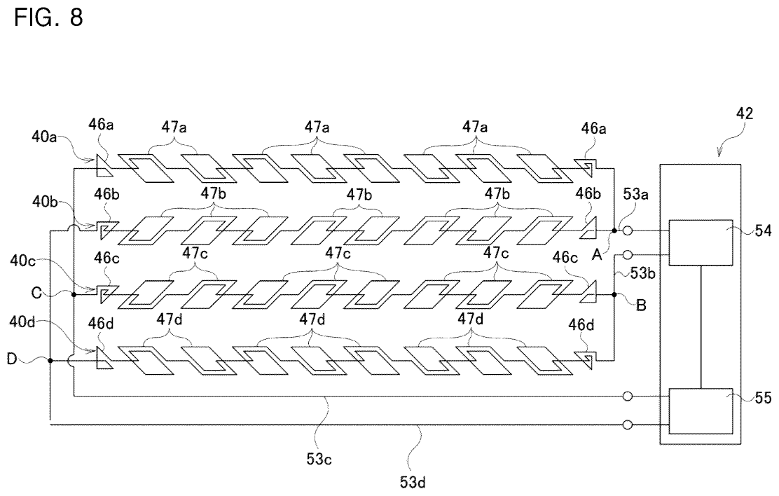

In this example, the signal line portion 43 has four signal lines 53a to 53d (see FIG. 8).

Of the four signal lines 53a to 53d, a first signal line 53a connects an end portion on one side of the first detection coil 40a and an end portion on one side of the second detection coil 40b in series, and is connected to a first sensor side contact provided in the connector 7. The first sensor side contact is engageable with a first device side contact provided in the device side connector. The first device side contact is electrically connected to one terminal of an oscillator 54 of the external device 42 through the cable.

A second signal line 53b connects an end portion on one side of the third detection coil 40c and an end portion on one side of the fourth detection coil 40d in series, and is connected to a second sensor side contact provided in the connector 7. The second sensor side contact is engageable with a second device side contact provided in the device side connector. The second device side contact is electrically connected to the other terminal of the oscillator 54 through the cable.

A third signal line 53c connects an end portion on the other side of the first detection coil 40a and an end portion on the other side of the third detection coil 40c in series, and is connected to a third sensor side contact provided in the connector 7. The third sensor side contact is engageable with a third device side contact provided in the device side connector. The third device side contact is electrically connected to one terminal of a voltmeter 55 of the external device 42 through the cable.

A fourth signal line 53d connects an end portion on the other side of the second detection coil 40b and an end portion on the other side of the fourth detection coil 40d in series, and is connected to a fourth sensor side contact provided in the connector 7. The fourth sensor side contact is engageable with a fourth device side contact provided in the device side connector. The fourth device side contact is electrically connected to the other terminal of the voltmeter 55 through the cable.

Each contact is mounted on the sensor-side contact mounting portion 80. The sensor side contact mounting portion 80 is housed inside the connector 7. Note that each contact is configured by a socket, a pin, and the like.

When the connector 7 is connected to the device side connector, a bridge circuit including the four detection coils 40a to 40d, the oscillator 54, and the voltmeter 55 is formed.

The oscillator 54 applies an AC voltage between a contact A between the end portion on the one side of the first detection coil 40a and the end portion on the one side of the second detection coil 40b, and a contact B between the end portion on the one side of the third detection coil 40c and the end portion on the one side of the fourth detection coil 40d. In addition, the voltmeter 55 detects a voltage between a contact C between the end portion on the other side of the first detection coil 40a and the end portion on the other side of the third detection coil 40c, and a contact D between the end portion on the other side of the second detection coil 40b and the end portion on the other side of the fourth detection coil 40d.

When a torque T is applied to the rotating shaft 2, stresses o with opposite signs (+/−) act on the outer circumferential surface of the rotating shaft 2 in a direction inclined at +45 degrees with respect to the axial direction and in a direction inclined at −45 degrees with respect to the axial direction. Due to an inverse magnetostriction effect, magnetic permeability increases in the direction in which a tensile stress (+σ) acts, and decreases in the direction in which a compressive stress (−σ) acts. In the magnetostrictive torque sensor 1 of this example, the voltage of the bridge circuit, which changes in accordance with the change in magnetic permeability of the rotating shaft 2, is detected by the voltmeter 55, and the direction and magnitude of the torque transmitted by the rotating shaft 2 are determined based on this detected value.

The signal lines 53a to 53d are configured by wiring patterns formed on the wiring layers 48a to 48d of the signal line portion 43.

The signal line portion 43 is pulled out to an outside space through the recessed accommodating portion 13.

In this example, a connection portion between the protruding portion 44 and the linear portion 45 of the signal line portion 43 is bent at approximately a right angle, a base end portion of the linear portion 45, that is, an end portion on the inner side in the radial direction, is positioned inside the recessed accommodating portion 13, and a tip-end portion of the linear portion 45, that is, a portion on the outer side in the radial direction, is pulled out to the outside space.

In this example, the connection portion between the protruding portion 44 and the linear portion 45 is bent at a substantially right angle, and thus the detection portion 41 can be prevented from lifting up from the inner cylindrical portion 10.

In other words, in a case in which the flexible substrate is bent at the connection between the detection portion and the signal line portion, a force of the bent part attempting to elastically restore to its original state may act on the detection portion, causing the detection portion to lift up from the inner cylindrical portion of the holder.

On the other hand, in this example, the connection portion between the protruding portion 44 protruding in the short side direction from the one long side of the detection portion 41 and the linear portion 45 extending in the long side direction from the protruding portion 44 is bent at approximately a right angle, and thus it is possible to prevent a force from acting on the detection portion 41 to cause the detection portion 41 to lift up from the inner cylindrical portion 10 of the holder 4 due to a force of the bent portion attempting to elastically restore to its original state.

In addition, in this example, the base end portion of the linear portion 45 extends in a direction substantially perpendicular to the inner cylindrical portion 10 and the outer cylindrical portion 12 of the holder 4. Therefore, even in a case in which a pulling force is applied to the tip end portion of the linear portion 45, it is possible to prevent a force from being applied to the holder 4 that would rotate the holder 4.

Moreover, the base end portion of the linear portion 45 is sandwiched on the inside of the recessed accommodating portion 13 between the opposing surface 16a of the one side wall portion 15a and the one outer side surface 32a of the protruding portion 31.

In particular, in this example, in a state in which the protruding portion 31 is pressed into the recessed accommodating portion 13, the force of the protrusion 39 on the other outer side surface 32b of the protruding portion 31 attempting to elastically restore to its original state causes the protruding portion 31 to be pressed in a direction pressing the one outer side surface 32a against the opposing surface 16a of the one side wall portion 15a. Therefore, the base end portion of the linear portion 45 is tightly sandwiched between the opposing surface 16a of the one side walls 15a and the one outer side surfaces 32a of the protruding portion 31. Therefore, even in a case in which a pulling force is applied to the tip-end portion of the linear portion 45, the force can prevent the detection portion 41 from being pulled to the outer side in the radial direction and lifting up from the inner cylindrical portion 10.

In addition, in this example, the linear portion 45 is curved in an approximately crank shape between the opposing surface 16a of the one side wall portion 15a and the one outer side surface 32a of the protruding portion 31 and along the opposing surface 16a and the outer side surface 32a. Therefore, when a force in a pulling direction is applied to the tip-end portion of the linear portion 45, the linear portion 45 is pressed against the connection portion between the holder side second guide surface 18 and the holder side inclined guide surface 19 on the opposing surface 16a, and against the connection portion between the cover side first guide surface 33 and the cover side inclined guide surface 35 on the outer side surface 32a, and the contact surface pressure at these contact portions increases. As the contact surface pressure increases, the frictional resistance acting between the linear portion 45 and the opposing surface 16a and between the linear portion 45 and the outer side surface 32a increases. As a result, the detection portion 41 can be prevented from being pulled to the outer side in the radial direction and lifting up from the inner cylindrical portion 10.

That is, in this example, the connection portion between the holder side second guide surface 18 and the holder side inclined guide surface 19 on the opposing surface 16a, and the connection portion between the cover side first guide surface 33 and the cover side inclined guide surface 35 on the outer side surface 32a each correspond to a protruding corner portion. In addition, the connection portion between the cover side second guide surface 34 and the cover side inclined guide surface 35 on the outer side surface 32a, and the connection portion between the holder side first guide surface 17 and the holder side inclined guide surface 19 on the opposing surface 16a correspond to a recessed corner portion.

In a case of implementing the magnetostrictive torque sensor according to the present disclosure, the shapes of the opposing surface 16a and the outer side surface 32a that sandwich the linear portion 45 can be changed as appropriate as long as the detection portion 41 can be prevented from lifting up from the inner cylindrical portion 10.

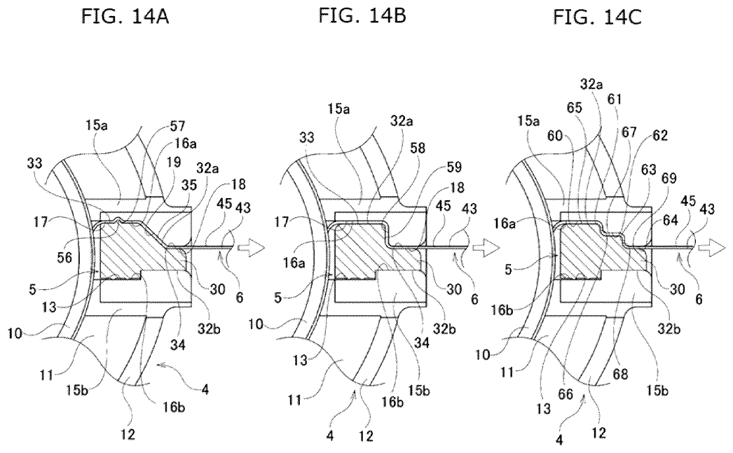

For example, in a first variation of this example illustrated in FIG. 14A, a small protruding portion 56 is provided on the cover side first guide surface 33 of the outer side surface 32a, and a small recessed portion 57 is provided on the holder side first guide surface 17 of the opposing surface 16a. In this variation, when a pulling force is applied to the tip-end portion of the linear portion 45, the linear portion 45 is pressed against the small protruding portion 56 in addition to the connection portion between the holder side second guide surface 18 and the holder side inclined guide surface 19 of the opposing surface 16a, and the connection portion between the cover side first guide surface 33 and the cover side inclined guide surface 35 of the outer side surface 32a. As a result, the contact surface pressure between these contact portions and the linear portion 45 and between the small protruding portion 56 and linear portion 45 increases, and the detection portion 41 is prevented from lifting up from inner cylindrical portion 10.

In this variation, each of the connection portion between the holder side second guide surface 18 and the holder side inclined guide surface 19, the connection portion between the cover side first guide surface 33 and the cover side inclined guide surface 35, and the small protruding portion 56 corresponds to a protruding corner portion. In addition, each of the connection portion between the cover side second guide surface 34 and the cover side inclined guide surface 35, the connection portion between the holder side first guide surface 17 and the holder side inclined guide surface 19, and the small recessed portion 57 corresponds to a recessed corner portion.

Note that it is also possible to provide a plurality of small protruding portions and small recessed portions. Moreover, a small protruding portion may be provided on the opposing surface of the one side wall portion, and a small recessed portion may be provided on the one outer side surface.

In a second variation of this example illustrated in FIG. 14B, the opposing surface 16a of the one side wall portion 15a is configured by connecting the holder side first guide surface 17 on the inner side in the radial direction and the holder side second guide surface 18 on the outer side in the radial direction by a holder side stepped surface 58 facing the inner side in the radial direction. Furthermore, the one outer side surface 32a is configured by connecting the cover side first guide surface 33 on the inner side in the radial direction and the cover side second guide surface 34 on the outer side in the radial direction by a cover side stepped surface 59 facing the outer side in the radial direction.

In this variation, when a pulling force is applied to the tip-end portion of the linear portion 45, the linear portion 45 is pressed against the connection portion between the holder side second guide surface 18 and the holder side stepped surface 58 of the opposing surface 16a, and the connection portion between the cover side first guide surface 33 and the cover side stepped surface 59 on the outer side surface 32a. As a result, surface pressure between these contact portions and the linear portion 45 increases, and the detection portion 41 is prevented from lifting up from the inner cylindrical portion 10.

In this variation, each of the connection portion between the holder side second guide surface 18 and the holder side stepped surface 58, and the connection portion between the cover side first guide surface 33 and the cover side stepped surface 59 corresponds to a protruding corner portion. In addition, each of the connection portion between the cover side second guide surface 34 and the cover side stepped surface 59, and the connection portion between the holder side first guide surface 17 and the holder side stepped surface 58 corresponds to a recessed corner portion.

In a third variation of this example illustrated in FIG. 14C, the opposing surface 16a of the one side wall portion 15a and the one outer side surface 32a of the protruding portion 31 are each configured in a stepped shape. More specifically, the opposing surface 16a has in order from the inner side in the radial direction, a holder side first guide surface 60, a holder side first stepped surface 61, a holder side second guide surface 62, a holder side second stepped surface 63, and a holder side third guide surface 64.

The holder side second guide surface 62 is positioned offset closer to the other side wall portion 15b than the holder side first guide surface 60, and the holder side third guide surface 64 is positioned offset closer to the other side wall portion 15b than the holder side second guide surface 62. In addition, the holder side first guide surface 60, the holder side second guide surface 62, and the holder side third guide surface 64 are arranged substantially parallel to each other. The holder side first guide surface 60 and the holder side second guide surface 62 are connected by the holder side first stepped surface 61 facing the inner side in the radial direction, and the holder side second guide surface 62 and the holder side third guide surface 64 are connected by the holder side second stepped surface 63 facing the inner side in the radial direction.

The outer side surface 32a has, in order from the inner side in the radial direction, a cover side first guide surface 65, a cover side first stepped surface 66, a cover side second guide surface 67, a cover side second stepped surface 68, and a cover side third guide surface 69.

The cover side second guide surface 67 is positioned offset closer to the one outer side surface 32b than the cover side first guide surface 65, and the cover side third guide surface 69 is positioned offset closer to the other side wall portion 15b than the cover side second guide surface 67. In addition, the cover side first guide surface 65, the cover side second guide surface 67, and the cover side third guide surface 69 are arranged approximately parallel to each other. The cover side first guide surface 65 and the cover side second guide surface 67 are connected by the cover side first stepped surface 66 facing the outer side in the radial direction, and the cover side second guide surface 67 and the cover side third guide surface 69 are connected by the cover side second stepped surface 68 facing the outer side in the radial direction.

In this variation, when a pulling force is applied to the tip-end portion of the linear portion 45, the linear portion 45 is pressed against the connection portion between the holder side third guide surface 64 and the holder side second stepped surface 63 of the opposing surface 16a, the connection portion between the holder side second guide surface 62 and the holder side first stepped surface 61, the connection portion between the cover side second stepped surface 68 and the cover side second guide surface 67 of the outer side surface 32a, and the connection portion between the cover side first stepped surface 66 and the cover side first guide surface 65. As a result, the contact surface pressure between these contact portions and the linear portion 45 increases, and the detection portion 41 is prevented from lifting up from the inner cylindrical portion 10.

In this variation, each of the connection portion between the holder side third guide surface 64 and the holder side second stepped surface 63, the connection portion between the holder side second guide surface 62 and the holder side first stepped surface 61, the connection portion between the cover side second step surface 68 and the cover side second guide surface 67, and the connection portion between the cover side first stepped surface 66 and the cover side first guide surface 65 corresponds to a protruding corner portion. In addition, each of the connection portion between the holder side second stepped surface 63 and the holder side second guide surface 62, the connection portion between the holder side first stepped surface 61 and the holder side first guide surface 60, the connection portion between the cover side third guide surface 69 and the cover side second stepped surface 68, and the connection portion between the cover side second guide surface 67 and the cover side first stepped surface 66 corresponds to a recessed corner portion.

The connector 7 is attached to the tip-end portion of the signal line portion 43. The connector 7 and the tip-end portion of the signal line portion 43 are joined by adhesion, soldering, or the like.

In addition, the connector 7 is supported by the cover 5.

In this example, the connector 7 has a connector body 78 and a supported plate portion 79.

The connector body 78 has a socket S into which the device-side connector is inserted. Sensor side contacts to which signal lines 53a to 53d are connected are provided inside of the socket S.

In this example, the connector body 78 is configured in a substantially rectangular columnar shape. However, in a case of implementing the magnetostrictive torque sensor according to the present disclosure, the shape of the connector body is not limited to a substantially rectangular columnar shape, and may be arbitrary shape.

The supported plate portion 79 is configured in a substantially rectangular flat plate shape. The supported plate portion 79 is joined and fixed to one side surface in the axial direction of the four side surfaces of the connector body 78.

In this example, the connector 7 is supported with respect to the cover 5 by engaging end portions on both sides in a width direction (edge portions on both sides in the circumferential direction) of the supported plate portion 79 with the slits 30a, 30b of the support plate portion 27 of the cover 5. In this example, in a state in which the connector 7 is supported with respect to the cover 5, the socket S faces the outer side in the radial direction.

In the magnetostrictive torque sensor 1 according to this example, by changing the shape of the connector 7 and/or the shape of the cover 5, the orientation of the socket S of the connector 7, that is, the connection direction of the device-side connector, can be changed.

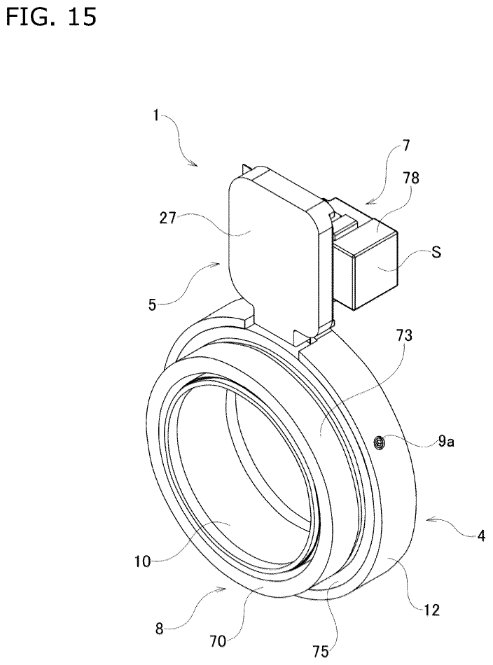

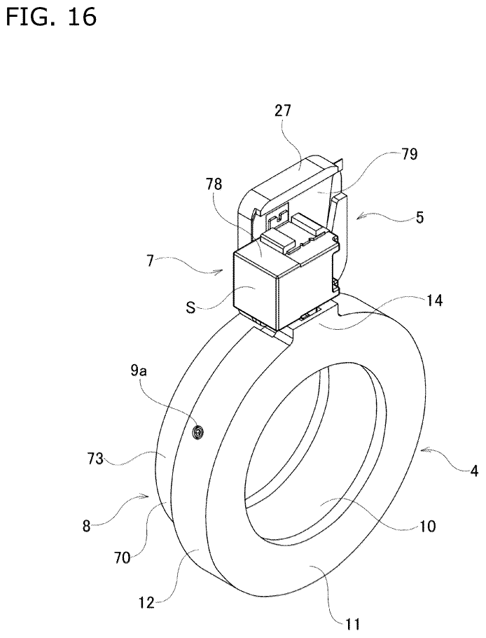

More specifically, for example, as illustrated in FIG. 15 and FIG. 16, by forming slits on radially opposing side surfaces of a recessed portion provided in a side surface on the one side in the axial direction of the support plate portion 27, and locking edge portions on both sides in the width direction of the supported plate portion 79 of the connector 7 with the slits, the connector 7 can be supported with respect to the cover 5 so that the socket S faces in the circumferential direction.

In short, in the magnetostrictive torque sensor 1 of this example, the connection direction of the device-side connector can be appropriately changed by simply changing the shape of the connector 7 and/or the shape of the cover 5 without changing the shape of the holder 4. Therefore, it is possible to ensure good attachment of the magnetostrictive torque sensor 1 to the fixed portion 3 while suppressing an increase in the manufacturing cost of the magnetostrictive torque sensor 1.

In addition, in the magnetostrictive torque sensor 1 of this example, damage to the flexible substrate 6, particularly the signal line portion 43, can be prevented during the work of attaching the magnetostrictive torque sensor 1 to the fixed portion 3.

In other words, in a case in which a band-shaped signal line portion provided on the flexible substrate is pulled out from the holder that houses the detection portion of the flexible substrate, care must be taken when performing the work of attaching the magnetostrictive torque sensor to the fixed part so as not to damage the signal line portion, which may reduce workability.

On the other hand, in this example, the connector 7 is supported by the cover 5, which prevents damage to the signal line portion 43 during work of the attaching the magnetostrictive torque sensor 1 to the fixed portion 3, making it easier to ensure workability.

Moreover, in this example, the connector 7 is supported by the cover 5. In other words, the cover 5 for covering the opening on the other side in the axial direction of the recessed accommodating portion 13 also functions as a bracket for supporting the connector 7. Therefore, there is no need to provide a separate bracket for supporting the connector 7, and the number of parts can be reduced, which makes it easier to keep costs down.

Note that in a case of implementing the technique according to the present disclosure, structure is not limited to that of this example and various structures may be adopted as long as the connector can be supported by the cover. More specifically, for example, the connector may be configured to be supported by a screw or the like relative to a supported portion of the cover.

The magnetic ring 8 is also called a back yoke, and has a function of preventing magnetic flux generated in the detection coils 40a to 40d from leaking to the outside. The magnetic ring 8 has a ring side cylindrical portion 70, a ring side fitting surface 71, and a ring side locking hole 72.

In this example, the magnetic ring 8 is composed only of a ring side cylindrical portion 70, and is configured to have a substantially cylindrical shape as a whole.

The ring side cylindrical portion 70 is arranged around the detection portion 40. In this example, the ring side cylindrical portion 70 has a small diameter portion 73 in a portion on the other side in the axial direction, and has a large diameter portion 74 at an end portion on the one side in the axial direction with an outer diameter larger than that of the small diameter portion 73. That is, the ring side cylindrical portion 70 has an outer circumferential surface in the form of a stepped cylinder, with the outer circumferential surface of the small diameter portion 73 and the outer circumferential surface of the large diameter portion 74 connected by a step surface 75 facing the other side in the axial direction. In contrast, the inner circumferential surface of the small diameter portion 73 and the inner circumferential surface of the large diameter portion 74 are located on the same cylindrical surface. Therefore, a thickness in the radial direction of the large diameter portion 74 is thicker than a thickness in the radial direction of the small diameter portion 73.

The ring side fitting surface 71 is fitted to the holder side fitting surface 24 without looseness. In this example, the ring side fitting surface 71 is provided on the outer circumferential surface of the large diameter portion 74. More specifically, the ring side fitting surface 71 is provided over the entire outer circumferential surface of the large diameter portion 74, and is configured as a single cylindrical surface whose outer diameter does not change in the axial direction.

In this example, the ring side fitting surface 71 has an outer diameter dimension that is slightly smaller than the inner diameter dimension of the holder side fitting surface 24. Therefore, in a state in which the magnetostrictive torque sensor 1 is assembled, the holder side fitting surface 24 and the ring side fitting surface 71 are fitted together by a spigot-fit, which is a clearance fit with no looseness in the radial direction.

In the magnetostrictive torque sensor 1 of this example, the holder side fitting surface 24 of the holder 4 and the ring side fitting surface 71 of the magnetic ring 8 are fitted together without any looseness. Therefore, the coaxiality of the holder 4 and the magnetic ring 8 can be satisfactorily ensured, and a magnetic circuit passing through the rotating shaft 2, the holder 4, and the magnetic ring 8 can be stably configured.

However, when implementing the magnetostrictive torque sensor of the present disclosure, the holder side fitting surface and the ring side fitting surface may also be fitted by press-fitting (including light press-fitting).

In addition, in this example, the axial length of the holder side fitting surface 24 and the axial length of the ring side fitting surface 71 are substantially the same. In other words, a length in the axial direction of the outer cylindrical portion 12 and a length of the large diameter portion 74 are substantially the same. Therefore, in a state in which the magnetostrictive torque sensor 1 is assembled, a position in the axial direction of the stepped surface 75 and a position in the axial direction of an end surface on the other side in the axial direction of the outer cylindrical portion 12 approximately coincide with each other. That is, the stepped surface 75 and the end surface on the other side in the axial direction of the outer cylindrical portion 12 are positioned on substantially the same plane.

However, a length in the axial direction of an outer diameter side cylindrical portion can also be made shorter or longer than a length in the axial direction of the large diameter portion.

The ring side locking hole 72 is provided so as to open to the outer circumferential surface of the large diameter portion 74, that is, the ring side fitting surface 71. In this example, ring side locking holes 72 are provided so as to open at five locations equally spaced apart in the circumferential direction of the ring side fitting surface 71.

In this example, the ring side locking hole 72 has a circular opening shape and is configured as a bottomed hole in which only an end portion on the outer side in the radial direction is open. However, in a case of implementing the magnetostrictive torque sensor according to the present disclosure, the opening shape of the ring side locking hole can be changed as appropriate depending on the shape of the positioning member. In addition, the ring side locking hole may be formed so as to penetrate the magnetic ring in the radial direction.

The magnetic ring 8 is made of a magnetic material and is configured as a single member. The magnetic material of the magnetic ring 8 may be, for example, an iron-based alloy such as alloy steel for machine construction or stainless steel.

The positioning members 9a, 9b extend between the holder side locking holes 25 of the holder 4 and the ring side locking holes 72 of the magnetic ring 8. Thus, it is possible to reliably prevent relative displacement between the holder 4 and the magnetic ring 8 in the axial direction and circumferential direction even in a case in which the holder 4 and/or the magnetic ring 8 expands or contracts due to temperature changes. That is, in the magnetostrictive torque sensor 1 of this example, the bond strength between the holder 4 and the magnetic ring 8, specifically, the bond strength in the axial direction and circumferential direction, can be sufficiently ensured. The magnetostrictive torque sensor 1 of this example includes five positioning members 9a, 9b.

Of the five positioning members 9a, 9b, the length of three positioning members 9a is equal to or smaller than the sum of the dimension in the radial direction of the holder side locking hole 25 and a depth in the radial direction of the ring side locking hole 72. Therefore, each of the positioning members 9a has an outer portion in the radial direction positioned (inserted) inside the holder side locking hole 25 and has an inner portion in the radial direction positioned (inserted) inside the ring side locking hole 72. In other words, an end portion on the outer side in the radial direction of the positioning member 9a does not protrude on the outer side in the radial direction from the opening portion on the outer side in the radial direction of the holder side locking hole 25.

The length of the remaining two positioning members 9b is longer than the sum of the dimension in the radial direction of the holder side locking hole 25 and the depth in the radial direction of the ring side locking hole 72. Therefore, each of the positioning members 9b has an intermediate portion in the radial direction positioned (inserted) inside the holder side locking hole 25 and has an inner portion in the radial direction positioned (inserted) inside the ring side locking hole 72. In other words, an end portion on the outer side in the radial direction of the positioning member 9b protrudes on the outer side in the radial direction from the opening portion on the outer side in the radial direction of the holder side locking hole 25.

In this example, the positioning members 9a, 9b are configured by a partially cylindrical spring pin having a linear or wave-shaped slit at one position in the circumferential direction. Each of the positioning members 9a, 9b is inserted into the holder side locking hole 25 and the ring side locking hole 72 in a state in which the outer diameter thereof is reduced by elastically narrowing the width of the slit, and then is elastically restored to the original shape. As a result, each of the positioning members 9a, 9b is tightly fitted into at least one of the holder side locking hole 25 and the ring side locking hole 72, and extends between the holder side locking hole 25 and the ring side locking hole 72.

In a case of implementing the magnetostrictive torque sensor according to the present disclosure, the positioning member is not particularly limited as long as relative displacement between the holder and the magnetic ring can be prevented. For example, the positioning member may be configured by a columnar or cylindrical pin. In addition, a cross-sectional shape of the positioning member is not limited to a circle, but may be a non-circular shape such as a partially cut circle or a polygon. Alternatively, the positioning member may be configured by a screw. In that case, the ring side locking hole provided in the magnetic ring is a screw hole.

In this example, the positioning members 9a, 9b are made of a metal material such as an iron-based alloy or a light alloy. However, the material of the positioning members is not particularly limited as long as sufficient bonding strength between the holder and the magnetic ring can be ensured, and synthetic resins and the like may also be used.

The magnetostrictive torque sensor 1 is supported and fixed to the fixed part 3 in a state in which rotation relative to the fixed part 3 is prevented by fitting the outer cylindrical portion 12 of the holder 4 with a fixed side fitting surface 76 provided on the inner circumferential surface of the fixed part 3 and arranging the end portions on the outer side in the radial direction of the two positioning members 9b inside locking recessed portions 77 formed on the fixed side fitting surface 76. In a state in which the magnetostrictive torque sensor 1 supported by and fixed to the fixed portion 3, the magnetostrictive torque sensor 1 is arranged around the rotating shaft 2. In other words, the magnetostrictive torque sensor 1 is supported by and fixed to the fixed portion 3 with the rotating shaft 2 inserted inside the inner cylindrical portion 10.

In this example, in a state in which the magnetostrictive torque sensor 1 is supported by and fixed to the fixed portion 3, a part of the fixed portion 3 comes in contact with or closely faces the outer end portion in the radial direction of the positioning members 9a, 9b. Thus, the positioning members 9a and 9b are prevented from coming off.

### REFERENCE SIGNS LIST

1 Magnetostrictive torque sensor
2 Rotating shaft
3 Fixed portion
4 Holder
5 Cover
6 Flexible substrate
7 Connector
8 Magnetic ring
9a, 9b Positioning member
10 Inner cylindrical portion
11 Side plate portion
12 Outer cylindrical portion
13 Recessed accommodating portion
14 Bottom plate portion
15a, 15b Side wall portion
16a, 16b Opposing surface
17 Holder side first guide surface
18 Holder side second guide surface
19 Holder side inclined guide surface
20 Holder side first flat surface
21 Holder side second flat surface
22 Stepped surface
23a, 23b Pedestal surface
24 Holder side fitting surface
25 Holder side locking hole
26 Connector support portion
27 Support plate portion
28 Covering plate portion
29 Recessed portion
30a, 30b Slit
31 Protruding portion
32a, 32b Outer side surface
33 Cover side first guide surface
34 Cover side second guide surface
35 Cover side inclined guide surface
36 Cover side first flat surface
37 Cover side second flat surface
38 Stepped surface
39 Protrusion
40a First detection coil
40b Second detection coil
40c Third detection coil
40d Fourth detection coil
41 Detection portion
42 External device
43 Signal line portion
44 Protruding portion
45 Linear portion
46 Coil piece
47a to 47d Coil piece
48a First wiring layer
48b Second wiring layer
48c Third wiring layer
48d Fourth wiring layer
49a First coverlay film
49b Second coverlay film
49c Third coverlay film
49d Fourth coverlay film
50a First adhesive layer
50b Second adhesive layer
50c Third adhesive layer
50d Fourth adhesive layer
51a First base film
51b Second base film
52 Double-sided tape
53a First signal line
53b Second signal line
53c Third signal line
53d Fourth signal line
54 Oscillator
55 Voltmeter
56 Small protruding portion
57 Small recessed portion
58 Holder side stepped surface
59 Cover side stepped surface
60 Holder side first guide surface
61 Holder side first stepped surface
62 Holder side second guide surface
63 Holder side second stepped surface
64 Holder side third guide surface
65 Cover side first guide surface
66 Cover side first stepped surface
67 Cover side second guide surface
68 Cover side second stepped surface
69 Cover side third guide surface
70 Ring side cylindrical portion
71 Ring side fitting surface
72 Ring side locking hole
73 Small diameter portion
74 Large diameter portion
75 Stepped surface
76 Fixed side fitting surface
77 Locking recessed portion
78 Connector body
79 Supported plate portion
80 Sensor side contact mounting portion

1. A magnetostrictive torque sensor for measuring a torque applied to a rotating shaft having magnetostrictive properties, the magnetostrictive torque sensor comprising:
a holder having an inner cylindrical portion arranged around the rotating shaft; a side plate portion bent to an outer side in a radial direction from an end portion on one side in an axial direction of the inner cylindrical portion; an outer cylindrical portion bent from an end portion on the outer side in the radial direction of the side plate portion toward an other side in the axial direction; and a recessed accommodating portion configured to communicate an inner space located on an inner side in the radial direction of the outer cylindrical portion and an outer space located on the outer side in the radial direction of the outer cylindrical portion, and being open to the other side in the axial direction;
a cover configured to cover an opening portion on the other side in the axial direction of the recessed accommodating portion;
a flexible substrate having a detection portion including a plurality of detection coils and arranged around the inner cylindrical portion; and a signal line portion including a plurality of signal lines electrically connected to the plurality of detection coils, a part of which is accommodated inside the recessed accommodating portion; and
a connector attached to a tip-end portion of the signal line portion;
the cover having a connector support portion for supporting the connector.

2. The magnetostrictive torque sensor according to claim 1, wherein the cover has a support plate portion including the connector support portion; and a covering plate portion configured to cover an opening portion on the other side in the axial direction of the recessed accommodating portion.

3. The magnetostrictive torque sensor according to claim 1, wherein
the connector support portion is configured by a slit; and
the connector is supported by the cover by engaging a part of the connector with the slit.

4. The magnetostrictive torque sensor according to claim 1, wherein
the cover has a protruding portion arranged inside the recessed accommodating portion;
one of the recessed accommodating portion and the protruding portion has a protruding corner portion having increased contact surface pressure with the signal line portion in a case in which the signal line portion is pulled toward the outer space; and
the other of the recessed accommodating portion and the protruding portion has a recessed corner portion facing the protruding corner portion.

5. The magnetostrictive torque sensor according to claim 1, comprising a magnetic ring arranged around the detection portion.

6. The magnetostrictive torque sensor according to claim 5, wherein
the holder has a cylindrical surface-shaped holder side fitting surface, and a holder side locking hole;
the magnetic ring has a ring side fitting surface configured to fit with the holder side fitting surface and a ring side locking hole; and
the magnetostrictive torque sensor includes a positioning member extending between the holder side locking hole and the ring side locking hole.
